(19) United States
(12) Patent Application Publication
(10) Pub. No.: US 2022/0255817 A1
(43) Pub. Date: Aug. 11, 2022

(54) MACHINE LEARNING-BASED VNF ANOMALY DETECTION SYSTEM AND METHOD FOR VIRTUAL NETWORK MANAGEMENT

(71) Applicant: POSTECH Research and Business Development Foundation, Pohang-si (KR)

(72) Inventors: Won Ki HONG, Pohang-si (KR); Jae Hyoung YOO, Seoul (KR); Ji Bum HONG, Seoul (KR); Su Hyun PARK, Seoul (KR)

(21) Appl. No.: 17/480,070

(22) Filed: Sep. 20, 2021

(30) Foreign Application Priority Data
Feb. 9, 2021 (KR) 10-2021-0018674

(51) Int. Cl. H04L 12/26; H04L 12/24; G06F 9/455; G06N 20/00

(52) U.S. Cl. CPC H04L 43/065; H04L 43/067; H04L 43/0817; G06F 2009/45595; G06F 9/45558; G06N 20/00; H04L 41/0627

(57) ABSTRACT

A virtual network management-specific machine learning-based VNF anomaly detection system may comprise: a data collection unit configured to collect normal state data generated when a service is normally provided and abnormal state data generated through a fault injection method through a monitoring agent and a monitoring module in real time, store the collected data in a time-series database, and transmit the monitoring data to determine whether there is an abnormal state; and a data analysis unit configured to extract a feature necessary for detecting an abnormal state by pre-processing monitoring data received from the data collection unit and send data on the extracted data to an abnormal-state detection model so that the abnormal-state detection model analyzes data that is input in real time to determine whether there is an abnormal state and notifies a network manager when an abnormal state occurs.

### CROSS-REFERENCE TO RELATED APPLICATIONS

This application claims priority to Korean Patent Application No. 10-2021-0018674, filed on Feb. 9, 2021, with the Korean Intellectual Property Office (KIPO), the entire content of which is hereby incorporated by reference.

### BACKGROUND

### 1. Technical Field

Exemplary embodiments of the present disclosure relate to a virtual network management-specific machine learning-based virtualized network function (VNF) anomaly detection system and method.

### 2. Related Art

With the rapid development of Software-Defined Networking (SDN)/Network Function Virtualization (NFV) technology, telecommunication operators and cloud data center operators are introducing and operating Virtualized Network Function (VNF) in which network functions are virtualized. As the scale is gradually increasing, new management issues, such as resource allocation and performance management of VNFs and fault management of a virtual network connecting VNFs, are increasing. In order to solve overall management issues related to SDN/NFV, it is necessary to check and analyze, in real time, resources used by VNF operating on a server inside a data center and abnormal states of a virtual network. In the past, abnormal states were detected based on a threshold in order to check the resources of the virtual network and the abnormal states of the network. Recently, along with an increase of attempts to manage networks without human intervention utilizing machine learning technology, an abnormal-state detection method based on machine learning technology is also emerging.

However, the conventional threshold-based detection method or machine learning-based detection method, which is for detecting abnormal states on the basis of relatively simple metrics such as the CPU utilization or memory usage of a server, has a problem in that it is highly likely to cause a false alarm. The present disclosure proposes a method of detecting an abnormal state of VNF based on a service state (anomaly detection). The proposing method includes a method of analyzing a network state and VNF resources through machine learning technology.

Anomaly detection is an important element of management and security of a virtual network and virtual resources that operate in an NFV environment such as a virtual machine (VM) and VNF, including a physical server operating inside a data center. Network managers use an abnormal-state detection method in order to check whether their services provided in a virtualized environment operate normally, whether the use state of allocated resources is appropriate, etc. and execute a policy appropriate to the situation.

There are two anomaly detection methods, i.e., a method of detecting an abnormal state of system resources and a method of detecting an abnormal state of network traffic. The method of detecting an abnormal state of system resources is a method of checking whether a CPU is being used excessively or whether a memory is insufficient by monitoring measurements such as CPU utilization, memory usage, and disk I/O access status. The method of detecting an abnormal state of network traffic uses a method of checking whether a sudden increase in traffic or a traffic attack such as a Denial of Service (DoS) occurs on the basis of the normal operating situation of the network traffic. Recently, many studies have been conducted to detect abnormal states by applying machine learning technology to the above two detection methods.

As the system resource-based detection method, which is one of the above two methods for detecting abnormal states of VNF in order to manage NFV environments, a method of utilizing a statistic approach to determine abnormal states on the basis of a threshold was widely used in the past. Conventional detection methods set thresholds by utilizing statistical approaches such as a Seasonal Trend decomposition using LOESS (STL) algorithm that considers seasonality factors that change according to a fixed period in time-series data or 3-sigma rule that classifies a point apart from the mean of data distribution by three times the standard deviation as an exceptional situation. This statistical approach is efficient when the anomaly is defined as a single value, but has a limitation in that it cannot detect anomalies caused by complex conditions.

To this end, recently, studies are being conducted on detecting abnormal states of VNF using machine learning technology. Most of these studies are for detecting abnormal states utilizing supervised learning-based algorithms (Random Forest, Support Vector Machine, Neural Network, etc.) among three categories of machine learning such as supervised learning, unsupervised learning, and reinforcement learning. However, since most of the machine learning-based studies define abnormal states based on simple measurements such as CPU utilization and memory usage, it is necessary to define abnormal states in consideration of a resource usage state and whether Service Level Agreement (SLA) is violated in terms of services in operation.

In addition, conventional statistical-based and machine learning-based abnormal-state detection methods define abnormal states on the basis of measurement thresholds such as CPU, memory, and disk access. Also, with the machine learning-based abnormal-state detection method, it is possible to learn abnormal states through data correlations. However, the definition of the abnormal states has a limitation in that when a measurement for resource use temporarily rises for a short time, this causes false alarms and does not consider aspects of services provided through VNFs.

### SUMMARY

Accordingly, exemplary embodiments of the present disclosure are provided to substantially obviate one or more problems due to limitations and disadvantages of the related art.

Exemplary embodiments of the present disclosure provide a more accurate anomaly detection method by defining an abnormal state in consideration of a service aspect such as an SLA violation when an abnormal state of a VNF is detected to manage an NFV environment.

To this end, data collected by monitoring resource usage, network states, and SLA violation information in a virtual network is applied to machine learning. The collected data undergoes a labeling process that extracts meaningful features from the collected data and classifies the data into normal and abnormal states so that the data can be used for learning based on a supervised learning-based machine learning algorithm.

The proposed method uses eXtreme Gradient Boosting (XGBoost), which is known to have the best performance among tree-based algorithms, for more accurate classification accuracy and faster training. Thus, an anomaly detection model is generated, and then the classification accuracy of the model is verified and used in an anomaly detection system.

Ultimately, the present disclosure aims to implement an anomaly detection system that overcomes the limitations of conventional methods by achieving high classification accuracy with little error.

According to an exemplary embodiment of the present disclosure for achieving the above-described objective, a virtual network management-specific machine learning-based virtualized network function (VNF) anomaly detection system, which is related to an abnormal-state detection apparatus for detecting an abnormal state of a VNF operating in a virtual network of a network function virtualization (NFV) infrastructure formed in a physical network through virtualization, may comprise: a data collection unit configured to collect normal state data generated when a service is normally provided and abnormal state data generated through a fault injection method through a monitoring agent and a monitoring module in real time, store the collected data in a time-series database, and transmit the monitoring data to determine whether there is an abnormal state; and a data analysis unit configured to extract a feature necessary for detecting an abnormal state by pre-processing monitoring data received from the data collection unit and send data on the extracted data to an abnormal-state detection model so that the abnormal-state detection model analyzes data that is input in real time to determine whether there is an abnormal state and notifies a network manager when an abnormal state occurs.

The data collection unit may comprise a monitoring agent configured to periodically collect a resource usage state of each virtual machine operating in the virtual network and send collected monitoring data to the monitoring module; and a dashboard configured to provide the monitoring data stored in the database in time-series in a visualized form.

According to another exemplary embodiment of the present disclosure for achieving the above-described objective, a virtual network management-specific machine learning-based virtualized network function (VNF) anomaly detection method may comprise: an NFVI monitoring operation for monitoring a network function virtualization infrastructure (NFVI) in order to train an abnormal-state detection model; a fault injection operation for generating an abnormal state of a virtualized network function (VNF); a pre-processing operation for converting monitoring data collected in a previous operation into a form suitable for training the abnormal-state detection model; and an abnormal-state detection model training performance evaluation operation for training the abnormal-state detection model through an abnormal-state detection algorithm and deriving an optimal abnormal-state detection model through comparison of a result of verifying the trained abnormal state detection model.

The virtual network management-specific machine learning-based VNF anomaly detection method may further comprise a feedback operation for re-training the abnormal-state detection model through the abnormal-state detection algorithm on the basis of the optimal abnormal-state detection model derived in the abnormal-state detection model training performance evaluation operation.

The NFVI monitoring operation may be an operation in which: a monitoring agent periodically collects monitoring measurements, which indicate a resource usage state of each virtual machine operating in a virtual network, a monitoring module receives data on the collected monitoring measurements from the monitoring agent and collects the data on the collected monitoring measurements in a time-series database, and a dashboard receives, in a visualized form desired by a user, data converted into a dataset for learning and stored in the database after the data is pre-processed.

The fault injection operation may be an operation of generating, through a fault injection technique, an abnormal state in software and hardware that is likely to occur in a virtual network in which a VNF operates using a technique used to control the frequency of occurrence of an abnormal state occurring in an actual operating environment.

The fault injection operation may be an operation of generating an abnormal state through a fault injection technique that causes an abnormal state in a virtual machine in which a VNF operates or causes overload to the extent that normal service cannot be guaranteed by transmitting a large amount of traffic.

The fault injection operation may be: an operation of directly injecting a fault such as CPU load, memory shortage, disk I/O access failure, network latency, and network packet loss into a virtual machine where a VNF operates; or an operation of generating a situation that exceeds an allowable range of access to and request for traffic or service, resulting in packet processing latency and packet drop by kernel.

The pre-processing operation may comprise a feature selection operation for distinguishing and selecting values that are criteria for determining normal and abnormal states among measurements collected through the monitoring, removing items with features that are similar to or overlapping with each other from the collected measurements, extracting features for distinguishing normal and abnormal states of a VNF, and using data on the extracted features to perform model training.

The pre-processing operation may comprise a data labeling operation for classifying data at each time into normal and abnormal states to use extracted feature data in a supervised learning-based machine learning algorithm.

The pre-processing operation may be an operation of: defining an abnormal state on the basis of a request state of service and information for determining an SLA violation that occurs inside a VNF due to system and traffic overload generated by fault injection; and generating a dataset by labeling a case in which an SLA violation and a service request failure occurs as an abnormal state and a case other than the abnormal state as a normal state.

The abnormal-state detection model training performance evaluation operation may comprise an operation of generating an anomaly detection model through learning using a supervised learning-based eXtreme Gradient Boosting (XGBoost) algorithm through a labeled dataset generated in the pre-processing operation.

The abnormal-state detection model training performance evaluation operation may comprise an operation of generating an anomaly detection model using XGBoost algorithm-based learning through a dataset labeled based on SLA violation information and an application service provision state in the fault injection operation and the pre-processing operation, verifying classification accuracy of the generated anomaly detection model, and evaluating performance of the model.

A model training operation may include, as a list of features selected for abnormal state detection training, a measurement time, a VNF instance name, CPU—idle time, CPU—time spent in interrupt processing, CPU—time spent in executing a process with nice value, CPU—time spent in softirq processing, CPU—CPU standby time by hypervisor, CPU—time spent in kernel mode, CPU—time spent in user mode, CPU—I/O standby time, Rx traffic bandwidth for a network interface, Tx traffic bandwidth for a network interface, the number of Rx packets in a network interface, the number of Tx packets in a network interface, Disk—free space, Disk—reserved space, Disk—space in use, Disk—read I/O, Disk—write I/O, Disk—I/O execution time, Memory—free space, Memory—buffered space, Memory—cached space, Memory—space in use, and network packet latency.

A model training operation may include, as a hyperparameter value of an XGBoost algorithm used by a VNF anomaly detection model, the number of trees, the maximum depth of a tree, the minimum number of observations in a leaf, a column sampling rate, a column sampling rate per tree, a metric to be used in early stopping, a value used for early stopping, L2 regularization, and L1 regularization.

In order to overcome these limitations, the present disclosure solves the problems by defining abnormal states corresponding to a service request and an SLA violation, and thus conventional studies show a classification accuracy between 80% and 90%, but an eXtreme Gradient Boosting (XGBoost) algorithm model used in the present disclosure is more suitable for preventing false alarms because it shows a high classification accuracy of 95% or more even in an abnormal-state definition method similar to conventional methods. When an abnormal state is defined in terms of a service, such as an SLA violation and service request failure that is more complicated than the threshold-based abnormal-state defining method, the present disclosure shows classification accuracy higher than or equal to that of the conventional method even if it is taken into account that actual verification is necessary.

Also, according to the present disclosure, various causes of abnormal states that may occur in real situations are included by generating abnormal states using various fault injection methods related to SLA violations as well as resource usage.

As a result, according to the present disclosure, it is possible to build a more precise VNF abnormal-state detection system by detecting abnormal states in consideration of service aspects and providing higher classification accuracy than before.

### BRIEF DESCRIPTION OF DRAWINGS

Exemplary embodiments of the present disclosure will become more apparent by describing the exemplary embodiments of the present disclosure in detail with reference to the accompanying drawings, in which:

FIG. 1 is a configuration diagram illustrating an example of a machine learning-based virtualized network function (VNF) abnormal-state detection system according to the present disclosure;

FIG. 2 is a flowchart illustrating an approximate algorithm of eXtreme Gradient Boosting (XGBoost) used by an abnormal-state detection model according to the present disclosure; and

FIGS. 3 and 4 are flowcharts illustrating the learning of a machine learning-based abnormal-state detection method according to the present disclosure.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

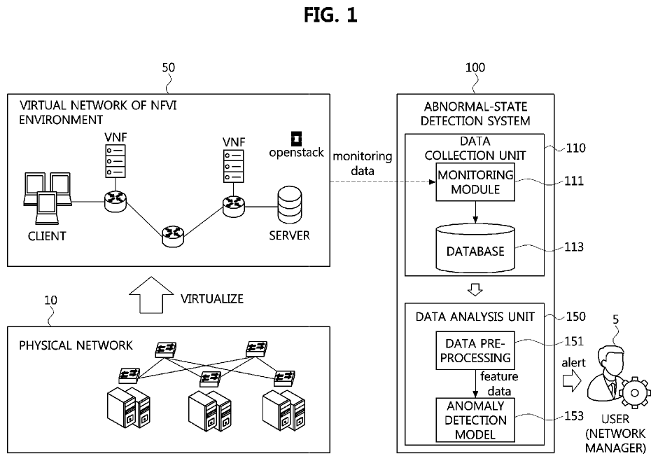

FIG. 1 is a configuration diagram illustrating an example of a virtual network management-specific machine learning-based virtualized network function (VNF) anomaly detection system 100 according to the present disclosure.

Referring to FIG. 1, there is disclosed a virtual network management-specific machine learning-based VNF anomaly detection system 100 that is applied to a virtual network 50 in a Network Functions Virtualization Infrastructure (NFVI) environment configured through virtualization in a physical network 10 proposed by the present disclosure.

The abnormal-state detection system 100 which is for detecting an abnormal state of the VNF according to the present disclosure and which operates in the virtual network 50 of the NFVI environment configured through virtualization in the physical network 10 includes a data collection unit 110 and a data analysis unit 150.

The data collection unit 110, which is a part that collects data from the virtual network 50 to train an abnormal-state detection model, collects data which has a state indicating that a service is normally provided and abnormal data which occurs through a fault injection method, such as resource shortage, network anomaly, and SLA violation, through a monitoring module 111 and a collect, which is a monitoring agent. The collected data is stored in a time-series database 113 and transmitted to the data analysis unit 150 in order to determine abnormal states.

The data collection unit 110 may further include a monitoring agent and a dashboard.

Monitoring measurements collected by the monitoring agent are stored in the database 113 through the monitoring module 111 and are visualized as a dashboard.

The monitoring agent periodically collects a resource usage state of each virtual machine operating in a virtual network. The monitoring measurements collected by the monitoring agent include a total of 73 items, including sub-items such as CPU utilization, memory usage, and network traffic load. The monitoring agent sends time-series monitoring data, which includes the collected measures, to the monitoring module 111.

The monitoring module 111 stores the collected time-series monitoring data in the database 113.

The database 113 stores the time-series monitoring data collected by the monitoring module 111.

The dashboard provides the time-series monitoring data stored in the database 113 in a visualized form desired by a user, such as a graph, a table, etc.

The data analysis unit 150 extracts features required to detect abnormal states as shown in Table 1 through data pre-processing 151 of the monitoring data received from the data collection unit 110 and sends the extracted feature data to an abnormal-state detection model 153.

Through the data pre-processing 151, the monitoring data stored in the database 113 is converted into dataset for learning.

By analyzing data that is input in real time, the abnormal-state detection model 153 determines whether there is an abnormal state and notifies a network manager 5 when an abnormal state occurs.

Table 1 is a list of features selected for abnormal-state detection learning.

TABLE 1

| Feature | Description |
|---|---|
| Time | Measurement time |
| instance | VNF instance name |
| cpu_idle | CPU-idle time |
| cpu_interrupt | CPU-time spent in interrupt processing |
| cpu_nice | CPU-time spent in executing process with nice value |
| cpu_softirq | CPU-time spent in softirq processing |
| cpu_steal | CPU-CPU standby time by hypervisor |
| cpu_system | CPU-time spent in kernel mode |
| cpu_user | CPU-time spent in user mode |
| cpu_wait | CPU-I/O standby time |
| network_rx_bytes | Rx traffic bandwidth for network interface |
| network_tx_bytes | Tx traffic bandwidth for network interface |
| network_rx_packets | number of Rx packets in network interface |
| network_tx_packets | number of Tx packets in network interface |
| disk_free | Disk-free space |
| disk_reserved | Disk-reserved space |
| disk_used | Disk-space in use |
| disk_read | Disk-read I/O |
| disk_write | Disk-write I/O |
| disk_Io_time | Disk-I/O execution time |
| mem_free | Memory-free space |
| mem_buffered | Memory-buffered space |
| mem_cashed | Memory-cached space |
| mem_used | Memory-space in use |
| hop-by-hop latency | Network packet latency |

The labeling of the dataset used to train the VNF anomaly detection model 153 through the method proposed by the present disclosure as normal data and abnormal data is achieved as follows. First, the dataset is generated by converting the collected monitoring data into a form suitable for model training as described above. To this end, a metric most relevant to a criterion for identifying abnormal states is selected from among metrics collected during the monitoring process. This process is performed in consideration of correlations between the metrics. Subsequently, in the case of labeling of normal and abnormal states of data, many fault alarms are caused when a metric such as CPU utilization is determined as a criterion for the labeling. Therefore, in the present disclosure, a case in which the performance degradation (performance bottleneck) of VNF occurs or an SLA violation occurs is defined as an abnormal state.

The performance degradation of VNF causes a shortage of available system resources due to the overload of the VNF or the injection of faults, which causes packet loss in the VNF. Accordingly, in the present disclosure, a packet loss rate being greater than or equal to 1% is defined as an abnormal state, and VNF having an anomaly (root cause localization) is detected. In the case of SLA violation, a criteria is different for each service, but an average response time and a service request failure rate are generally included. Thus, an abnormal state is defined as such an index, and also, an SLA violation criterion for each service is defined as an abnormal state. For example, for a web hosting service, a case in which an average response time is 0.5 seconds, one second, two seconds or more and a service request failure rate is 0.1%, 1%, 2% or more is defined as an SLA violation (based on GFD-R. 192-Web Service Agreement Specification).

Also, the eXtreme Gradient Boosting (XGBoost) algorithm used in the present disclosure is based on an ensemble learning technique that obtains a model with better performance than when training is performed through a single model by training and combining multiple models. XGBoost is an algorithm that corresponds to a boosting technique among ensemble learning techniques. The boosting technique increases classification accuracy in the next model training by increasing the weight of data with a classification error in the previously trained model. Unlike GBM, which is generally widely used among boosting-technique-based algorithms, XGBoost has an advantage.

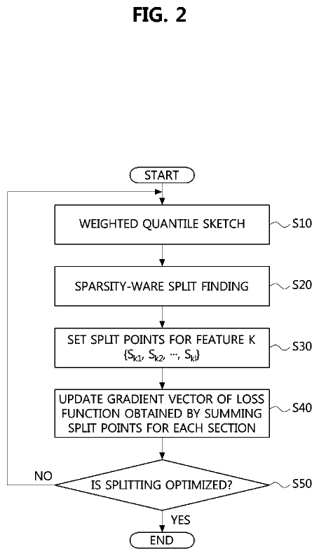

FIG. 2 is a flowchart illustrating an approximate algorithm of XGBoost used by an abnormal-state detection model according to the present disclosure.

Referring to FIG. 2, the algorithm of XGBoost used by an anomaly detection model according to the present disclosure will be described using Equations 1 to 4 below.

First, XGBoost prevents overfitting through an objective function to which regularization is applied as in Equation 1 to solve an overfitting issue of GBM.

L(φ)=Σᵢ₌₁ⁿl(yᵢ, ŷᵢ)+Σᵢ₌₁ⁿΩ(fᵢ) [Equation 1]

### l: Loss Function (ŷi^{t}: Predicted Value, yi: Actual Result Value)

In Equation 1, the first term l is a loss function (differentiable convex loss function), which represents the difference between the predicted value ŷᵢ of an i^{th} instance and the actual result value yᵢ. The second term Ω, which is a regularization technique that indicates the complexity of each tree, solves the fitting issue by controlling the complexity of the model in the process of minimizing the objective function by adding the number T of leaves of a tree and the norm ∥w∥² of a weight vector of the leaves to the loss function for each tree as shown in Equation 2.

$$Ω ( ℓ ) = γ T + \frac{1}{2} λ {‖ w ‖}^{2} \\ γ T \text{: Number of leaves of tree} \\ {‖ w ‖}^{2} \text{: Norm of weight vector of leaves} \qquad [ Equation 2 ]$$

In addition to the above-described objective function, XGBoost uses shrinkage scaling and column sub-sampling to solve the overfitting issue. The shrinkage scaling reduces the influence of existing trees or leaves on new trees in the stochastic optimization process by applying scaling to weights newly added at each stage of a boosting-based tree. The column sub-sampling increases a training speed by preventing overfitting compared to a conventional row-based sub-sampling.

Also, since the existing GBM uses a greedy algorithm in the process of searching for optimization points for all split points for each feature, high classification accuracy is provided, but there is a limitation in that the training time is long. In contrast, XGBoost uses an approximate algorithm as shown in FIG. 2 to search for an optimized split point. The approximate algorithm sets a candidate split point for each feature (S30) and sums gradient vectors of the loss function for split sections according to the quantiles of the feature distribution (S40). Based on the sum, the approximate algorithm computes a score for the splitting optimization and determines whether to finally confirm split point settings (S50).

In order to properly set a candidate split point for each feature, the approximate algorithm of XGBoost applies a weighted quantile sketch method (S10) and a sparsity-aware split finding method (S20) to search for a candidate split point. The quantile sketch method finds split points, {s_{k,1}, s_{k,2}, . . . , s_{k,l}} that are obtained by uniformly dividing data through an approximation factor c for dividing data for feature k by 1/ε as shown in Equation 3.

|rₖ(s_{k,j})−rₖ(s_{k,j+1})|<ε [Equation 3]

E: Approximation factor
s_{k,l}: j^{th} split point for feature k

In order to uniformly split data, a function rₖ representing the proportion of data smaller than each split point is defined as in Equation 4 and used for data splitting. In this case, Dₖ denotes a dataset in which a weight is applied to the feature k, and h denotes a data weight. XGBoost finds a split point while maintaining accuracy for weighted data through the quantile sketch method.

$${τ}_{k} ( z ) = \frac{1}{{Σ}_{( x , ℓ ) ∈ {D}_{k}} h} {Σ}_{( x , ℓ ) ∈ {D}_{k} x < z} h \\ {D}_{k} \text{: Dataset for feature} k \\ h \text{: Weight of data} \qquad [ Equation 4 ]$$

The sparsity-aware split finding method (S20) finds a split point in consideration of missing data and sparsity data when a missing value is generated due to omission of values in the data collection process or data is sparse. For example, by setting a default classification direction for each tree node, missing values are classified in the default classification direction when values are missing in the data.

Table 2 includes hyper-parameter values of the XGBoost algorithm used by a proposed VNF anomaly detection model.

TABLE 2

| Hyper-parameter | Value | Description |
|---|---|---|
| ntrees | 111 | Number of trees |
| max_depth | 5 | Maximum depth of tree |
| min_rows | 3 | Minimum number of |
| | | observations in leaf |
| col_sample_rate | 0.8 | Column sampling rate |
| col_sample_rate_per_tree | 0.8 | Column sampling rate |
| | | per tree |
| stopping_metric | Logloss | Metric to be used in |
| | | early stopping |
| stopping_tolerance | 0.0045469579205 | Value used for early |
| | | stopping |
| reg_lambda | 0.001 | L2 regularization |
| reg_alpha | 1 | L1 regularization |

In order to train the anomaly detection model based on the XGBoost algorithm and the dataset generated through the fault injection method in the NFV environment, the present disclosure optimizes the performance of the anomaly detection model using the hyper-parameters as shown in Table 2.

Data is labeled in order to verify the performance of the abnormal-state detection model generated based on this (S400). The labeled data is split into a training dataset of 75% and a test dataset of 25%, and then the abnormal-state detection model is trained. The performance of the abnormal-state detection model trained through the training dataset is evaluated through the 5-fold cross validation method. Accuracy, precision, reproduction rate (recall), F-measure (F1 score), and the like are used as items for evaluation of the abnormal-state detection model. Subsequently, the performance of the abnormal-state detection model is finally evaluated through test dataset that is not involved in training the abnormal-state detection model.

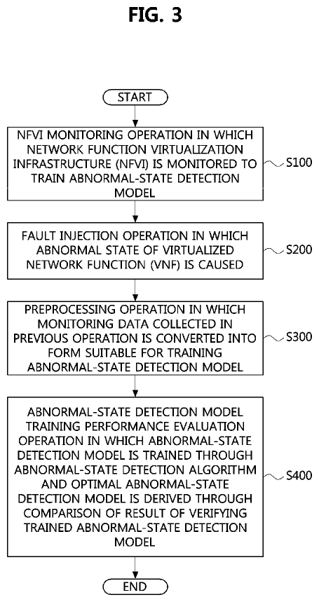

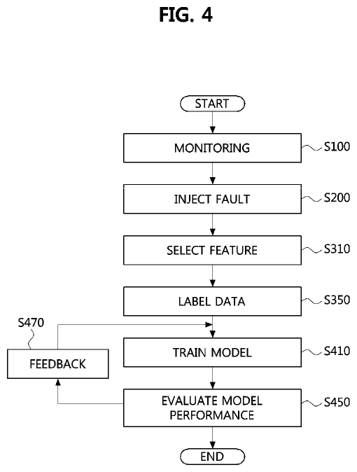

FIGS. 3 and 4 are flowcharts illustrating the training of a machine learning-based abnormal-state detection method according to the present disclosure.

Referring to FIGS. 3 and 4, the virtual network management-specific machine learning-based VNF anomaly detection method according to the present disclosure includes an NFVI monitoring operation (S100) for monitoring a network function virtualization infrastructure (NFVI) in order to train an abnormal-state detection model, a fault injection operation (S200) for generating an abnormal state of a VNF, a preprocessing operation (S300) for converting monitoring data collected in the previous operation into a form suitable for training the abnormal-state detection model, and an abnormal-state detection model training performance evaluation operation (S400) for training the abnormal-state detection model through an abnormal-state detection algorithm and deriving an optimal abnormal-state detection model through comparison of a result of verifying the trained abnormal-state detection model.

Here, the preprocessing operation (S300) includes a feature selection operation (S310) and a data labeling operation (S350), and the abnormal-state detection model training performance evaluation operation (S400) includes a model training operation (S410) and a model performance evaluation operation (S450).

Here, the abnormal-state detection model training performance evaluation operation (S400) further includes a feedback operation (S470) for re-training the abnormal-state detection model (S410) through an abnormal-state detection algorithm on the basis of the optimal abnormal-state detection model derived in the model performance evaluation operation (S450).

In describing the virtual network management-specific machine learning-based VNF anomaly detection method using the above-described virtual network management-specific machine learning-based VNF anomaly detection system according to the present disclosure, an anomaly detection model generation method according to the present disclosure is largely composed of four operations. In a first operation, which is the NFVI monitoring operation (S100), an NFVI environment is monitored to train an abnormal-state detection model. In a second operation, which is the fault injection operation (S200), an abnormal state of a VNF is generated. In a third operation, which is the preprocessing operation (S300), the feature selection operation (S310) and the data labeling operation (S350) are performed to convert monitoring data collected in the previous operation into a form suitable for training a machine learning model. Last, in the anomaly detection model training performance evaluation operation (S400), the abnormal-state detection model is trained through XGBoost algorithm (S410), and the model performance evaluation operation (S450) for deriving an optimal model through comparison of a result of verifying each model is performed.

In the NFVI monitoring operation (S100), monitoring measurements collected by a monitoring agent are stored in the database 113 through the monitoring module 111 and are visualized as a dashboard. The monitoring agent periodically collects a resource usage state of each virtual machine operating in a virtual network. The monitoring measurements collected by the monitoring agent include a total of 73 items, including sub-items such as CPU utilization, memory usage, and network traffic load. The monitoring agent sends the data to the monitoring module 111, and the monitoring module 111 stores the collected data in the time-series database 113. The stored data is pre-processed and then is converted into a dataset for learning. Through the dashboard, the data stored in the database 113 is provided in a visualized form desired by a user, such as a graph, a table, etc.

The fault injection operation (S200) is a technique used to control the frequency of occurrence of an abnormal state that occurs very rarely in an actual operating environment. Various abnormal states in software and hardware that can occur in the virtual network in which the VNF operates are generated through fault injection technology. There are two main methods to generate an abnormal state through the fault injection technology. The first method is to generate an abnormal state in the VM where the VNF operates, and the second method is to cause an overload to the extent that proper service cannot be guaranteed by transmitting a large amount of traffic. The first method injects faults directly into the VM where the VNF operates. This causes CPU load and memory shortage, disk I/O access failure, network latency, network packet loss, and the like. The second method causes network overload through a large amount of traffic, which makes the VNF consume a great deal of system resources and time to process incoming packets. For example, the second method causes a situation in which access to and requests for traffic or services are excessively input, resulting in packet processing latency and packet drop by kernel.

The preprocessing operation (S300) includes the feature selection operation (S310) and the data labeling operation (S350). First, the feature selection operation (S310) is an operation of identifying and selecting values that are criteria for determining normal and abnormal states of measurements collected through monitoring. In operation S310, items with features that are similar to or overlapping with each other are removed from the collected measurements. Through this process, features for determining the normal and abnormal states of the VNF are extracted, and the data is used for learning. The data labeling operation (S350) is an operation of classifying data for each time into a normal state and an abnormal state in order to allow the extracted feature data to be used in a supervised learning-based machine learning algorithm. The abnormal state is defined based on a request state of service and information that may determine an SLA violation occurring in the VNF due to system and traffic overload caused by fault injection. That is, cases in which an SLA violation and a service request failure occur are labeled as an abnormal state, and the other cases are labeled as a normal state to create a dataset.

Last, in the anomaly detection model training performance evaluation operation (S400), an anomaly detection model is trained using a supervised learning-based XGBoost algorithm through the labeled dataset generated in the preprocessing operation (S300) (S410). XGBoost is a decision tree-based machine learning algorithm which exhibits better performance in classifying and predicting typical data, unlike a neural network-based algorithm that exhibits good performance in predicting atypical data such as images or text. In particular, XGBoost utilizes a method of iteratively training an independent tree like Gradient Boosting Machine (GBM), which is a commonly used boosting technique-based algorithm, but solves the overfitting issue of the GBM and exhibits better performance than the GBM in terms of resource usage and training speed. In the anomaly detection model training performance evaluation operation (S400), an anomaly detection system 100 of a VNF operating in a series of processes, which include generating an anomaly detection model using XGBoost algorithm-based training through a labeled dataset on the basis of application service provision statuses and SLA violation information in the fault injection operation (S200) and the pre-processing operation (S300) (S410), verifying the classification accuracy of the generated anomaly detection model and evaluating the performance of the anomaly detection model (S450), and feeding an optimal anomaly detection model generated as a result of the anomaly detection model performance evaluation operation (S450) back to the abnormal-state detection model training operation (S410) (S470), is built and utilized to manage an NFV environment.

With the virtual network management-specific machine learning-based VNF anomaly detection system and method according to the present disclosure, it is possible to learn abnormal states through data correlations. However, a conventional machine learning-based abnormal-state detection method defines abnormal states on the basis of thresholds of measurements such as CPU and memory in defining the abnormal states and thus has a limitation in that many false alarms are induced and the state of an actually provided service is not considered.

Therefore, the virtual network management-specific machine learning-based VNF anomaly detection system and method according to the present disclosure solve the issues by defining an abnormal state corresponding to a service request and an SLA violation in order to overcome the limitation. Conventional studies exhibit a classification accuracy of 80 to 90%, but the XGBoost algorithm model used in the virtual network management-specific machine learning-based VNF anomaly detection system and method according to the present disclosure has a high classification accuracy of more than 95% even in an anomaly state definition method similar to that of the conventional method and thus is more suitable for preventing false alarms. When an abnormal state is defined in terms of a service, such as a more complicated SLA violation and service request failure than the threshold-based abnormal-state defining method, the present disclosure is expected to exhibit classification accuracy higher than or equal to that of the conventional method even if it is taken into account that actual verification is necessary.

Also, in the virtual network management-specific machine learning-based VNF anomaly detection system and method according to the present disclosure, various causes of abnormal states that may occur in real situations are included by generating abnormal states using various fault injection methods related to SLA violations as well as resource usage. As a result, with the virtual network management-specific machine learning-based VNF anomaly detection system and method according to the present disclosure, it is possible to build a more precise VNF abnormal-state detection system by considering a service aspect that detects an abnormal state and provides higher classification accuracy than before.

In the virtual network management-specific machine learning-based VNF anomaly detection system and method according to the present disclosure, a method of generating a machine learning-based VNF abnormal-state detection model is defined in order to solve NFV environment management issues that arise along with the advancement and complexity of the current NFV environment, and a method of detecting an abnormal state of an actually operating VNF by applying the generated model to the NFV environment is proposed.

An anomaly detection model training method used in the virtual network management-specific machine learning-based VNF anomaly detection system and method according to the present disclosure may generate an optimal model with the best accuracy through new machine-learning algorithms that are not used in the conventional methods, such as XGBoost.

In addition, with the virtual network management-specific machine learning-based VNF anomaly detection system and method according to the present disclosure, which are obtained by improving a method in which a conventional system detects an abnormal state on the basis of simple measurements such as CPU and memory, it is possible to realize a more precise anomaly detection system by defining an abnormal state in consideration of the state of a service including an SLA violation.

The operations of the method according to an embodiment of the present disclosure can also be embodied as computer-readable programs or codes on a computer-readable recording medium. The computer-readable recording medium includes any type of recording apparatus in which data readable by a computer system is stored. The computer-readable recording medium can also be distributed over network-coupled computer systems so that computer-readable programs or codes are stored and executed in a distributed fashion.

Also, examples of the computer-readable recording medium may include a hardware device such as ROM, RAM, and flash memory, which are specifically configured to store and execute program commands. The program commands may include high-level language codes executable by a computer using an interpreter as well as machine codes made by a compiler.

Although some aspects of the disclosure have been described in the context of an apparatus, it is clear that these aspects also represent a description of the corresponding method, where a block or apparatus corresponds to a method step or a feature of a method step. Analogously, aspects described in the context of a method step may also represent a description of a corresponding block or item or feature of a corresponding apparatus. Some or all of the method steps may be performed by means of (or by using) a hardware device such as, for example, a microprocessor, a programmable computer, or an electronic circuit. In some embodiments, one or more of the most important method steps may be performed by such a device.

In some embodiments, a programmable logic device (for example, a field-programmable gate array) may be used to perform some or all of the functionalities of the methods described herein. In some embodiments, a field-programmable gate array may cooperate with a microprocessor in order to perform one of the methods described herein. Generally, the methods are performed by any hardware device.

While the exemplary embodiments of the present disclosure and their advantages have been described in detail, it should be understood that various changes, substitutions and alterations may be made herein without departing from the scope of the present disclosure.

What is claimed is:

1. A virtual network management-specific machine learning-based virtualized network function (VNF) anomaly detection system, which is related to an abnormal-state detection apparatus for detecting an abnormal state of a VNF operating in a virtual network of a network function virtualization (NFV) infrastructure formed in a physical network through virtualization, the virtual network management-specific machine learning-based VNF anomaly detection system comprising:
a data collection unit configured to collect normal state data generated when a service is normally provided and abnormal state data generated through a fault injection method through a monitoring agent and a monitoring module in real time, store the collected data in a time-series database, and transmit the monitoring data to determine whether there is an abnormal state; and
a data analysis unit configured to extract a feature necessary for detecting an abnormal state by pre-processing monitoring data received from the data collection unit and send data on the extracted data to an abnormal-state detection model so that the abnormal-state detection model analyzes data that is input in real time to determine whether there is an abnormal state and notifies a network manager when an abnormal state occurs.

2. The virtual network management-specific machine learning-based VNF anomaly detection system of claim 1, wherein the data collection unit comprises a monitoring agent configured to periodically collect a resource usage state of each virtual machine operating in the virtual network and send collected monitoring data to the monitoring module; and a dashboard configured to provide the monitoring data stored in the database in time-series in a visualized form.

3. A virtual network management-specific machine learning-based virtualized network function (VNF) anomaly detection method comprising:
an NFVI monitoring operation for monitoring a network function virtualization infrastructure (NFVI) in order to train an abnormal-state detection model;
a fault injection operation for generating an abnormal state of a virtualized network function (VNF);
a pre-processing operation for converting monitoring data collected in a previous operation into a form suitable for training the abnormal-state detection model; and
an abnormal-state detection model training performance evaluation operation for training the abnormal-state detection model through an abnormal-state detection algorithm and deriving an optimal abnormal-state detection model through comparison of a result of verifying the trained abnormal state detection model.

4. The virtual network management-specific machine learning-based VNF anomaly detection method of claim 3, further comprising a feedback operation for re-training the abnormal-state detection model through the abnormal-state detection algorithm on the basis of the optimal abnormal-state detection model derived in the abnormal-state detection model training performance evaluation operation.

5. The virtual network management-specific machine learning-based VNF anomaly detection method of claim 3, wherein the NFVI monitoring operation is an operation in which:
a monitoring agent periodically collects monitoring measurements, which indicate a resource usage state of each virtual machine operating in a virtual network,
a monitoring module receives data on the collected monitoring measurements from the monitoring agent and collects the data on the collected monitoring measurements in a time-series database, and
a dashboard receives, in a visualized form desired by a user, data converted into a dataset for learning and stored in the database after the data is pre-processed.

6. The virtual network management-specific machine learning-based VNF anomaly detection method of claim 3, wherein the fault injection operation is an operation of generating, through a fault injection technique, an abnormal state in software and hardware that is likely to occur in a virtual network in which a VNF operates using a technique used to control the frequency of occurrence of an abnormal state occurring in an actual operating environment.

7. The virtual network management-specific machine learning-based VNF anomaly detection method of claim 3, wherein the fault injection operation is an operation of generating an abnormal state through a fault injection technique that causes an abnormal state in a virtual machine in which a VNF operates or causes overload to the extent that normal service cannot be guaranteed by transmitting a large amount of traffic.

8. The virtual network management-specific machine learning-based VNF anomaly detection method of claim 3, wherein the fault injection operation is:
an operation of directly injecting a fault such as CPU load, memory shortage, disk I/O access failure, network latency, and network packet loss into a virtual machine where a VNF operates; or
an operation of generating a situation that exceeds an allowable range of access to and request for traffic or service, resulting in packet processing latency and packet drop by kernel.

9. The virtual network management-specific machine learning-based VNF anomaly detection method of claim 3, wherein the pre-processing operation comprises a feature selection operation for distinguishing and selecting values that are criteria for determining normal and abnormal states among measurements collected through the monitoring, removing items with features that are similar to or overlapping with each other from the collected measurements, extracting features for distinguishing normal and abnormal states of a VNF, and using data on the extracted features to perform model training.

10. The virtual network management-specific machine learning-based VNF anomaly detection method of claim 3, wherein the pre-processing operation comprises a data labeling operation for classifying data at each time into normal and abnormal states to use extracted feature data in a supervised learning-based machine learning algorithm.

11. The virtual network management-specific machine learning-based VNF anomaly detection method of claim 3, wherein the pre-processing operation is an operation of:
defining an abnormal state on the basis of a request state of service and information for determining an SLA violation that occurs inside a VNF due to system and traffic overload generated by fault injection; and
generating a dataset by labeling a case in which an SLA violation and a service request failure occurs as an abnormal state and a case other than the abnormal state as a normal state.

12. The virtual network management-specific machine learning-based VNF anomaly detection method of claim 3, wherein the abnormal-state detection model training performance evaluation operation comprises an operation of generating an anomaly detection model through learning using a supervised learning-based eXtreme Gradient Boosting (XGBoost) algorithm through a labeled dataset generated in the pre-processing operation.

13. The virtual network management-specific machine learning-based VNF anomaly detection method of claim 3, wherein the abnormal-state detection model training performance evaluation operation comprises an operation of generating an anomaly detection model using XGBoost algorithm-based learning through a dataset labeled based on SLA violation information and an application service provision state in the fault injection operation and the pre-processing operation, verifying classification accuracy of the generated anomaly detection model, and evaluating performance of the model.

14. The virtual network management-specific machine learning-based VNF anomaly detection method of claim 3, wherein a model training operation comprises, as a list of features selected for abnormal state detection training, a measurement time, a VNF instance name, CPU—idle time, CPU—time spent in interrupt processing, CPU—time spent in executing a process with nice value, CPU—time spent in softirq processing, CPU—CPU standby time by hypervisor, CPU—time spent in kernel mode, CPU—time spent in user mode, CPU—I/O standby time, Rx traffic bandwidth for a network interface, Tx traffic bandwidth for a network interface, the number of Rx packets in a network interface, the number of Tx packets in a network interface, Disk—free space, Disk—reserved space, Disk—space in use, Disk—read I/O, Disk—write I/O, Disk—I/O execution time, Memory—free space, Memory—buffered space, Memory—cached space, Memory—space in use, and network packet latency.

15. The virtual network management-specific machine learning-based VNF anomaly detection method of claim 3, wherein a model training operation comprises, as a hyperparameter value of an XGBoost algorithm used by a VNF anomaly detection model, the number of trees, the maximum depth of a tree, the minimum number of observations in a leaf, a column sampling rate, a column sampling rate per tree, a metric to be used in early stopping, a value used for early stopping, L2 regularization, and L1 regularization.
